(19) United States
(12) Patent Application Publication
(10) Pub. No.: US 2025/0191044 A1
(43) Pub. Date: Jun. 12, 2025

(54) CONTENT SALES DEVICE, CONTENT SALES METHOD, AND CONTENT SALES PROGRAM

(71) Applicant: JVCKENWOOD Corporation, Yokohama-shi (JP)

(72) Inventor: Kenji YOSHIDA, Yokohama-shi (JP)

(21) Appl. No.: 19/053,876

(22) Filed: Feb. 14, 2025

Related U.S. Application Data
(63) Continuation of application No. PCT/JP2023/020001, filed on May 30, 2023.

(30) Foreign Application Priority Data
Aug. 26, 2022 (JP) 2022-134936
Aug. 26, 2022 (JP) 2022-134953
Aug. 26, 2022 (JP) 2022-134956
Aug. 26, 2022 (JP) 2022-134960
Aug. 26, 2022 (JP) 2022-134970
Aug. 26, 2022 (JP) 2022-134976

(51) Int. Cl. G06Q 30/0601; G06T 3/4038; G06T 7/00

(52) U.S. Cl. CPC G06Q 30/0621; G06T 3/4038; G06T 7/0002

(57) ABSTRACT

Each of a plurality of cameras is arranged to face the inside of a shooting area. An image storage unit stores image data generated by each camera. A composite image generator generates composite image data corresponding to image data obtained by shooting a subject from a position at a predetermined angle in any direction from a center point, based on image data generated by at least two cameras adjacent in a circumferential direction, with a predetermined direction from the center point taken as an angle of 0 degrees. A sales controller sells image data stored in the image storage unit or composite image data generated by the composite image generator as content when a purchaser of content selects an angle in any direction from the center point to purchase the content.

### CROSS-REFERENCE TO RELATED APPLICATIONS

This application is a continuation of PCT Application No. PCT/JP2023/020001, filed on May 30, 2023, and claims the priority of Japanese Patent Applications No. 2022-134936, No. 2022-134953, No. 2022-134956, No. 2022-134960, No. 2022-134970, and No. 2022-134976, filed on Aug. 26, 2022, the entire contents of all of which are incorporated herein by reference.

### BACKGROUND ART

The present invention relates to a content sales device, a content sales method, and a content sales program.

Images of subjects shot by a plurality of cameras may be sold as content.

### SUMMARY

It is expected that a new content sales device, a content sales method, and a content sales program will appear that can sell contents according to a request of purchaser.

A first aspect of one or more embodiments provides a content sales device including: an image storage unit configured to store image data generated by a plurality of cameras when each of the plurality of cameras is arranged to face an inside of a shooting area, and the plurality of cameras shoot a subject located in the shooting area; a center point setting unit configured to set a center point in the shooting area; a composite image generator configured to generate composite image data corresponding to image data obtained by shooting the subject from a position at a predetermined angle in any direction from the center point, based on image data generated by at least two cameras adjacent in a circumferential direction among the plurality of cameras, with a predetermined direction from the center point taken as an angle of 0 degrees; and a sales controller configured to sell image data stored in the image storage unit or composite image data generated by the composite image generator as content when a purchaser of content selects an angle in any direction from the center point to purchase the content.

A second aspect of one or more embodiments provides a content sales method including: storing image data generated by a plurality of cameras using an image storage unit included in a content sales server, when each of the plurality of cameras is arranged to face the inside of a shooting area, and the plurality of cameras shoot a subject located in the shooting area; setting a center point in the shooting area by a center point setting unit included in the content sales server; generating composite image data corresponding to image data obtained by shooting the subject from a position at a predetermined angle in any direction from the center point, with a composite image generator included in the content sales server, based on image data generated by at least two cameras adjacent in a circumferential direction among the plurality of cameras, with a predetermined direction from the center point taken as an angle of 0 degrees; and selling image data stored in the image storage unit or composite image data generated by the composite image generator as content with a sales controller, when a purchaser of content selects an angle in any direction from the center point to purchase the content.

A third aspect of one or more embodiments provides a content sales program stored in a non-transitory storage medium causing a computer to execute the steps of: storing image data generated by a plurality of cameras when each camera in the plurality of cameras is arranged to face the inside of a shooting area, and the plurality of cameras shoot a subject located in the shooting area; setting a center point in the shooting area by a center point setting unit included in a content sales server; generating composite image data corresponding to image data obtained by shooting the subject from a position at a predetermined angle in any direction from the center point, based on image data generated by at least two cameras adjacent in a circumferential direction among the plurality of cameras, with a predetermined direction from the center point taken as an angle of 0 degrees; and selling image data stored in the image storage unit or composite image data as content when a purchaser of content selects an angle in any direction from the center point to purchase the content.

### BRIEF DESCRIPTION OF THE DRAWINGS

FIG. 1 is a block diagram illustrating a content sales device according to a first embodiment.

FIG. 2 is a diagram illustrating an example of arrangement of a plurality of cameras.

FIG. 3 is a diagram illustrating an example of a purchaser of content at various angles.

FIG. 4 is a flowchart illustrating a content sales method according to a first embodiment, and processes that a content sales program according to a first embodiment causes a computer to execute according to a first embodiment.

FIG. 5 is a block diagram illustrating a content sales device according to a second embodiment.

FIG. 6 is a diagram illustrating a movement center point moving in a shooting area.

FIG. 7 is a flowchart illustrating a content sales method according to a second embodiment, and processes that a content sales program according to a second embodiment causes a computer to execute.

FIG. 8 is a block diagram illustrating a content sales device according to a third embodiment.

FIG. 9 is a diagram illustrating an example of a state in which image quality degradation occurs.

FIG. 10 is a flowchart illustrating a content sales method according to a third embodiment, and processes that a content sales program according to a third embodiment causes a computer to execute.

FIG. 11 is a block diagram illustrating a content sales device according to a fourth embodiment.

FIG. 12 is a diagram illustrating a state in which an angle is selected at each of two center points in a shooting area.

FIG. 13 is a diagram illustrating an example in which the direction of the angle selected at one of the two center points in the shooting area coincides with the direction of a connecting line connecting the two center points.

FIG. 14 is a flowchart illustrating a content sales method according to a fourth embodiment, and processes that a content sales program according to a fourth embodiment causes a computer to execute.

FIG. 15 is a block diagram illustrating a content sales device according to a fifth embodiment.

FIG. 16 is a diagram illustrating an example of a state in which a camera cannot shoot a subject due to the presence of an obstacle.

FIG. 17 is a flowchart illustrating a content sales method according to a fifth embodiment, and processes that a content sales program according to a fifth embodiment causes a computer to execute.

FIG. 18 is a block diagram illustrating a content sales device according to a sixth embodiment.

FIG. 19 is a diagram illustrating an example of three-dimensional arrangement of a plurality of cameras according to a sixth embodiment.

FIG. 20A is a diagram illustrating a preferred method of setting an angle in three dimensions by a three-dimension division angle setting unit according to a sixth embodiment.

FIG. 20B is a diagram illustrating a comparative example of the method of setting an angle in three dimensions according to a sixth embodiment.

FIG. 21 is a flowchart illustrating a content sales method according to a sixth embodiment, and processes that a content sales program according to a sixth embodiment causes a computer to execute.

### DETAILED DESCRIPTION

A content sales device, a content sales method, and a content sales program according to each embodiment will be described below with reference to the accompanying drawings.

### First Embodiment

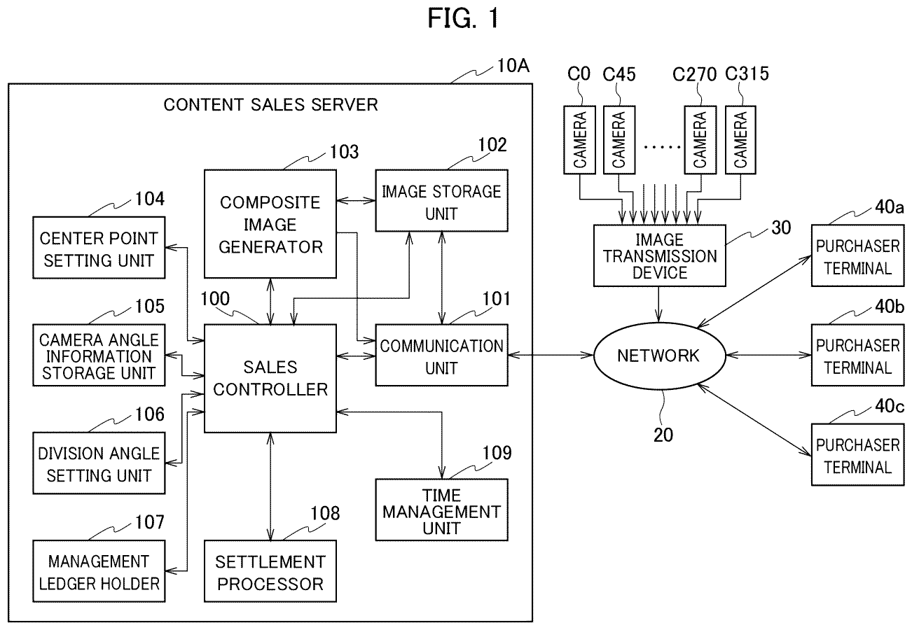

In FIG. 1, a content sales server 10A, an image transmission device 30, and purchaser terminals 40a to 40c are connected to a network 20. Typically, the network 20 is the Internet. A purchaser terminal that do not specify any one of the purchaser terminals 40a to 40c and other purchaser terminals is referred to as a purchaser terminal 40. The number of purchaser terminals 40 connected to the network 20 is optional. The purchaser terminals 40 may be any of a personal computer, a tablet, or a smartphone.

The content sales server 10A is a content sales device according to a first embodiment, and executes a content sales method according to a first embodiment. The content sales server 10A may be configured by a computer, and a central processor (CPU) may execute a content sales program according to a first embodiment that is stored in a non-transitory storage medium.

The content sales server 10A includes a sales controller 100, a communication unit 101, an image storage unit 102, a composite image generator 103, a center point setting unit 104, a camera angle information storage unit 105, a division angle setting unit 106, a management ledger holder 107, a settlement processor 108, and a time management unit 109.

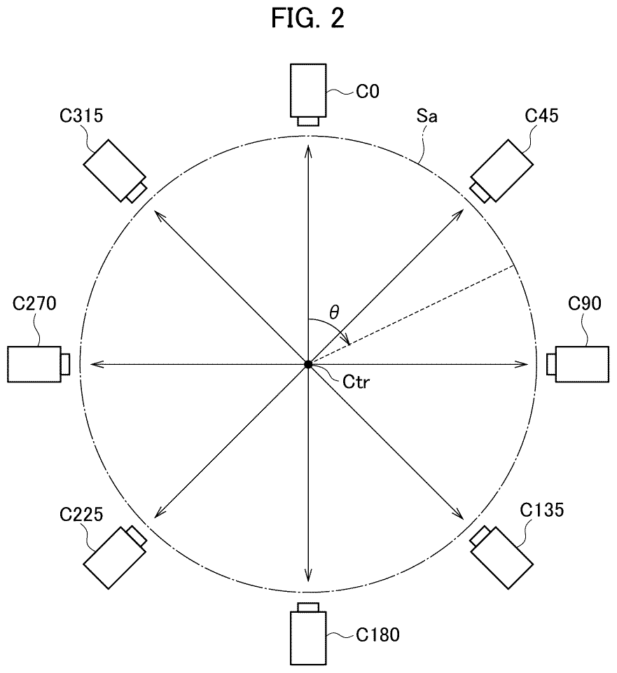

For example, eight cameras C0 to C315 are connected to the image transmission device 30. As illustrated in FIG. 2, as an example, the cameras C0 to C315 are concentrically arranged at equal angular intervals toward the inside of a shooting area Sa. Here, the cameras C0 to C315 are arranged toward the inside of the shooting area Sa. The cameras C0 to C315 are preferably arranged toward a center point Ctr of the shooting area Sa. A camera that does not specify any one of the cameras C0 to C315 is referred to as a camera C. Disposing the camera C toward the center point Ctr means that the line orthogonal to the angle of view of the camera C at a horizontal center of the angle of view of the camera C is located on the center point Ctr.

The center point Ctr in a first embodiment is fixed. The angles in the direction connecting the center point Ctr and the cameras C0 to C315 are 0 degrees, 45 degrees, 90 degrees, 135 degrees, 180 degrees, 225 degrees, 270 degrees, and 315 degrees, respectively. Any number of cameras C may be used. The plurality of cameras C may be arranged in an elliptical shape, or not necessarily arranged at equal angular intervals.

Returning to FIG. 1, the cameras C0 to C315 shoot the subject located at the center point Ctr from the directions of the above-mentioned angles different from each other, and supply the image data to the image transmission device 30. The image data is video data. The image transmission device 30 transmits the image data to the content sales server 10A via the network 20. The content sales server 10A sells the image data generated by the cameras C0 to C315, or the composite image data generated based on the image data generated by the cameras C0 to C315, to the purchaser as content.

The image data generated by the cameras C0 to C315 may be directly supplied to the content sales server 10A.

The communication unit 101 receives image data transmitted from the image transmission device 30. The image storage unit 102 stores the received image data. When the content sales server 10A delivers content live, the image storage unit 102 temporarily stores the image data. When the content sales server 10A delivers content on demand, the image storage unit 102 stores the image data.

The composite image generator 103 may generate composite image data based on the image data stored in the image storage unit 102. The center point setting unit 104 sets the coordinates of the center point Ctr on the plane. The camera angle information storage unit 105 stores the angle information of the cameras C0 to C315.

The camera angle information storage unit 105 may store preset angle information. The camera angle information storage unit 105 stores coordinates of the cameras C0 to C315 on the plane, and may store angle information obtained by calculating each angle based on the coordinates of the center point Ctr and the coordinates of the cameras C0 to C315. The sales controller 100 may calculate angle information of the cameras C0 to C315, and the camera angle information storage unit 105 may store the angle information.

The division angle setting unit 106 sets the unit of angle of the image data to be sold as content when viewing in a direction of a circumference from the center point Ctr in FIG. 2. That is, the division angle setting unit 106 sets how many divisions in the circumferential direction of 360 degrees the image data is to be sold as content. When the division angle setting unit 106 sets five degrees, the content sales server 10A can sell image data of 0 degrees, 5 degrees, 10 degrees, 15 degrees, 20 degrees . . . , 335 degrees, 340 degrees, 345 degrees, 350 degrees, and 355 degrees as content.

Content sales may mean transfer of ownership of content.

A management ledger holder 107 holds a management ledger for managing an ID of each content in association with an ID of a purchaser. The settlement processor 108 processes settlement when content is sold. The time management unit 109 manages content times. When the content sales server 10A distributes content live, the time management unit 109 manages time as time currently progresses. When the content sales server 10A distributes content on demand, the time management unit 109 manages the time from starting to ending of the content.

A purchaser who intends to purchase content selects an angle to purchase the content in any of the purchaser terminals 40. When the communication unit 101 receives from any of the purchaser terminals 40 a purchase request for content with, for example, an angle of 0 degrees, the sales controller 100 sells image data generated by the camera C0 arranged at the angle of 0 degrees stored in the image storage unit 102. Similarly, when the communication unit 101 receives a purchase request for content with an angle of 45 degrees, the sales controller 100 sells the image data generated by the camera C45 arranged at the angle of 45 degrees stored in the image storage unit 102.

In this manner, when the communication unit 101 receives a request to purchase content at any angle at which the cameras C0 to C315 are arranged, the sales controller 100 sells the image data generated by the camera C arranged at any angle stored in the image storage unit 102.

As illustrated in FIG. 2, when the communication unit 101 receives a request to purchase content at an angle θ between an angle of 45 degrees and an angle of 90 degrees, for example, the sales controller 100 sells composite image data generated by the composite image generator 103 based on the image data generated by the camera C45 and the image data generated by the camera C90. The composite image data, which is generated by the composite image generator 103 based on the image data generated by at least two cameras C adjacent in a circumferential direction, corresponds to the image data obtained by shooting the subject located at the center point Ctr from a position between two cameras C adjacent in the circumferential direction.

In this manner, when the sales controller 100 receives a request to purchase content at an angle θ between the angles at which two cameras C adjacent in the circumferential direction are located, the sales controller 100 sells the composite image data generated by the composite image generator 103 based on the image data generated by the two cameras C.

As described above, a purchaser can purchase composite image data of 5 degrees, 10 degrees, 15 degrees, 20 degrees, . . . , 335 degrees, 340 degrees, 345 degrees, 350 degrees, and 355 degrees which are angles set in the division angle setting unit 106, except for any of the angles at which the cameras C0 to C315 are located.

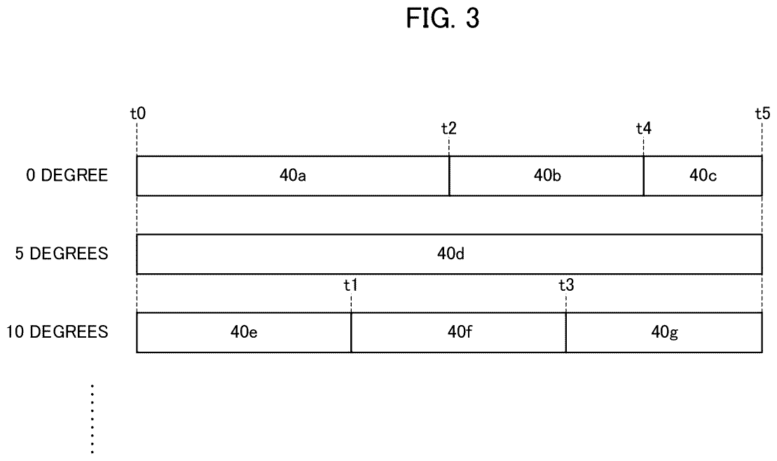

Only one purchaser can purchase the image data or composite image data at each angle for one time period. As illustrated in FIG. 3 as an example, for content with an angle of 0 degrees, a purchaser who owns the purchaser terminal 40a purchases image data during the time from time to, which is a start time of the content, to time t2. The purchaser who owns the purchaser terminal 40b purchases image data during the time from time t2 to time t4, and the purchaser who owns the purchaser terminal 40c purchases image data during the time from time t4 to time t5, which is an end time of the content.

In the contents with an angle of 5 degrees, the purchaser who owns an unillustrated purchaser terminal 40d in FIG. 1 purchases composite image data during all the time from time t0 to time t5. For content with an angle of 10 degrees, the purchasers who owns unillustrated purchaser terminals 40e, 40f, and 40g in FIG. 1 purchase composite image data during each time from time t0 to time t1, time t1 to time t3, and time t3 to time t5, respectively.

The sales controller 100 associates an ID of content for each angle and time period, and an ID of a purchaser, with each other as illustrated in FIG. 3 for management by a management ledger held in the management ledger holder 107. An ID of content for each angle and time period, and an ID of a purchaser, are recorded in the management ledger in association with each other. Only one purchaser may purchase image data or composite image data for each angle at all times. In this case, an ID of content for each angle and an ID of a purchaser are recorded in association with each other in the management ledger.

Composite image data generated based on image data generated by two adjacent cameras C is inferior in quality to image data generated by the cameras C0 to C315. Therefore, it is preferable that the content sales server 10A sets a selling price for selling the composite image data lower than selling price for selling the image data generated by the cameras C0 to C315 as is. The settlement processor 108 manages the selling price for selling the image data generated by the cameras C0 to C315 and the composite image data generated by the composite image generator 103.

The selling price of the composite image data may be uniform, or the selling price may be set higher at angles close to the angles of the cameras C0 to C315 such as 5 degrees, 40 degrees, and 50 degrees than at other angles. Individual selling prices may be set for each angle.

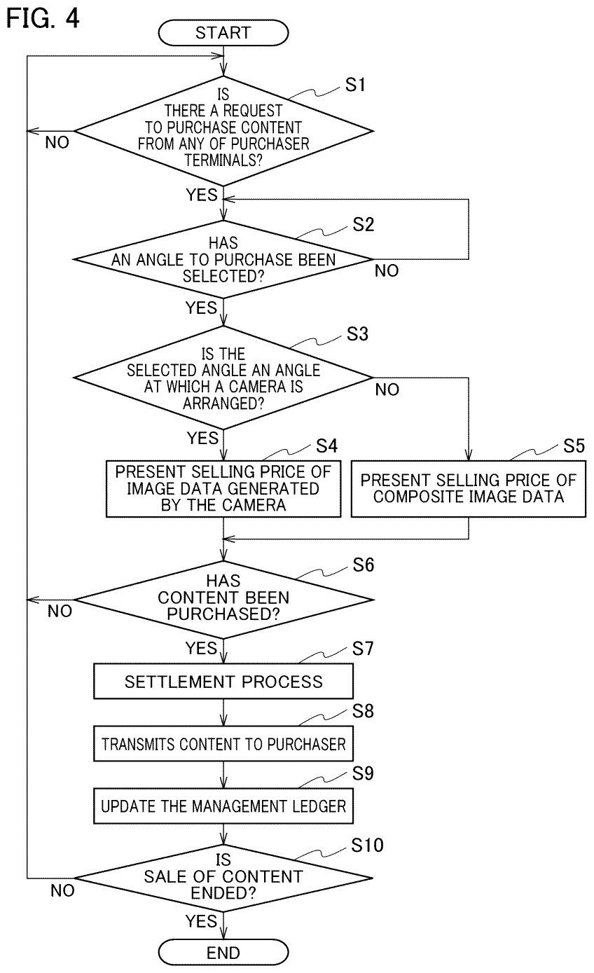

A content sales method executed by the content sales server 10A, and processes that the content sales program causes the sales controller 100 to execute will be described with reference to a flowchart illustrated in FIG. 4. When the content sales server 10A starts operation, the sales controller 100 determines in step S1 whether there is a request to purchase content from any of the purchaser terminals 40. If there is no request to purchase content (NO), the sales controller 100 repeats a process in step S1.

If there is a request to purchase content (YES) in step S1, the sales controller 100 determines in step S2 whether or not an angle to purchase has been selected. If an angle to purchase has not been selected (NO), the sales controller 100 repeats the process of step S2. If an angle to purchase has been selected (YES), the sales controller 100 determines in step S3 whether the selected angle is an angle at which the camera C is arranged.

If the angle selected in step S3 is an angle at which the camera C is arranged (YES), the sales controller 100 presents the selling price of the image data generated by the camera C to the purchaser terminal 40 in step S4, and causes a process in step S6 to follow. If the angle selected in step S3 is not an angle at which the camera C is located (NO), the sales controller 100 presents the selling price of composite image data in step S5, and causes the process in step S6 to follow.

In step S6, the sales controller 100 determines whether content has been purchased. If content has not been purchased (NO), the sales controller 100 repeats the processes in steps S1 to S6. If content has been purchased (YES), the sales controller 100 causes the settlement processor 108 to execute a settlement process in step S7, and then transmits the content to the purchaser in step S8. The sales controller 100 records the ID of the purchased content in the management ledger in association with the ID of the purchaser in step S9, and updates the management ledger.

The sales controller 100 determines whether to end the sale of the content in step S10. If the sale of the content is not ended (NO), the sales controller 100 repeats the processes in steps S1 to S10. If the sale of the content is ended (YES), the sales controller 100 ends the process. In the flow chart illustrated in FIG. 4, the selling price is indicated when an angle is selected, but the flow may be such that a plurality of sets of the angle and the selling price is indicated in the user interface first, and the purchaser selects one of the sets. Angles may be represented graphically so that a purchaser can purchase content after confirming images for each angle.

As described above, the content sales server 10A as the content sales device according to a first embodiment includes the sales controller 100, the image storage unit 102, and the composite image generator 103. The image storage unit 102 stores image data generated by the plurality of cameras C when the cameras C arranged to face the center point Ctr set in the shooting area Sa shoots a subject located at the center point Ctr. Based on the image data generated by at least two cameras C adjacent in the circumferential direction of the plurality of cameras C, the composite image generator 103 generates composite image data corresponding to image data obtained by shooting a subject from a position between two cameras C adjacent in the circumferential direction.

It is assumed that a purchaser of content purchases content by selecting an angle in a direction in which any of the cameras C is located. At this time, the sales controller 100 sells the image generated by the camera C corresponding to the selected angle stored in the image storage unit 102 as content. It is assumed that the purchaser purchases the content by selecting an angle located in a direction between two cameras C adjacent in the circumferential direction among the cameras C. At this time, the sales controller 100 sells composite image data generated by the composite image generator 103 as content.

It is preferable that the sales controller 100 sells image data stored in the image storage unit 102 at a first selling price and sells composite image data generated by the composite image generator 103 at a second selling price lower than the first selling price.

The division angle setting unit 106 sets the unit of angle for selling content in the circumferential direction of 360 degrees, with an angle of a predetermined direction in the shooting area Sa as seen from the center point Ctr being 0 degrees. Therefore, an angle for selling content can be optionally set in units of 1 degree or 5 degrees. The sales controller 100 sells content in units of an angle set in the division angle setting unit 106. Therefore, the content sales server 10A can sell content in units of any angle.

The sales controller 100 may sell content at each angle to only one purchaser in one time period. The sales controller 100 may sell the content at each angle to only one purchaser at all times.

In the content sales method according to a first embodiment, the image storage unit 102 stores image data, and the composite image generator 103 generates composite image data. In the content sales method according to a first embodiment, the sales controller 100 sells image data as a content and sells composite image data as a content. In the content sales method according to a first embodiment, it is preferable to sell image data stored in the image storage unit 102 at a first selling price, and to sell composite image data generated by the composite image generator 103 at a second selling price lower than the first selling price.

The content sales program according to a first embodiment causes a computer included in the content sales server 10A to execute a step of storing image data and a step of generating composite image data. The content sales program according to a first embodiment causes a computer included in the content sales server 10A to execute a step of selling image data as contents and a step of selling composite image data as contents. The content sales program according to a first embodiment preferably causes the computer to execute a step of selling image data at a first selling price and a step of selling composite image data at a second selling price lower than the first selling price.

According to the content sales server 10A, the content sales method, and the content sales program according to a first embodiment, content according to a request of a purchaser of content can be sold. In the content sales server 10A, the content sales method, and the content sales program according to a first embodiment, content may be sold at an appropriate price according to a state of the content. The state of the content here refers to the quality or the degree of image quality depending on the angle.

### Second Embodiment

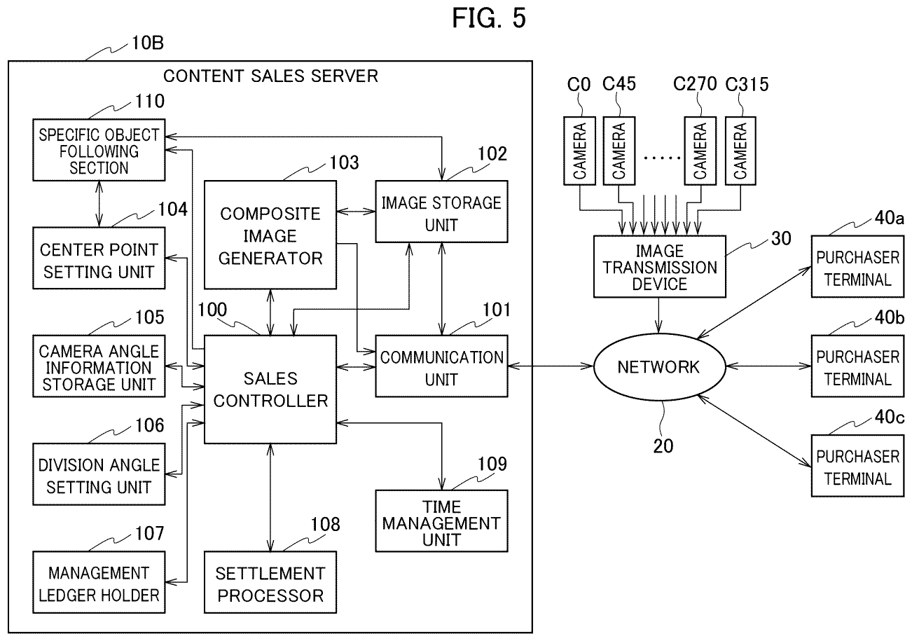

In FIG. 5, a content sales server 10B is connected to the network 20 in place of the content sales server 10A illustrated in FIG. 1. In FIG. 5, the same parts as those in FIG. 1 are denoted by the same reference signs, and the description thereof may be omitted. The content sales server 10B is a content sales device according to a second embodiment, and executes a content sales method according to a second embodiment. The content sales server 10B executes a content sales program according to a second embodiment.

As illustrated in FIG. 5, the content sales server 10B includes a specific object following unit 110. The specific object following unit 110 follows a specific object from the subject that has been shot. The purchaser terminals 40 receive any of the image data generated by the cameras C0 to C315, and a purchaser designates a specific object. The purchaser terminals 40 can designate a specific object by color, shape, or the like. The specific object is a specific performer or the like shot by the cameras C0 to C315.

The sales controller 100 receives information on a specific object designated by the communication unit 101, and instructs the specific object following unit 110 to follow the specific object. The sales controller 100 instructs the center point setting unit 104 to set any position of the specific object followed by the specific object following unit 110 as a center point.

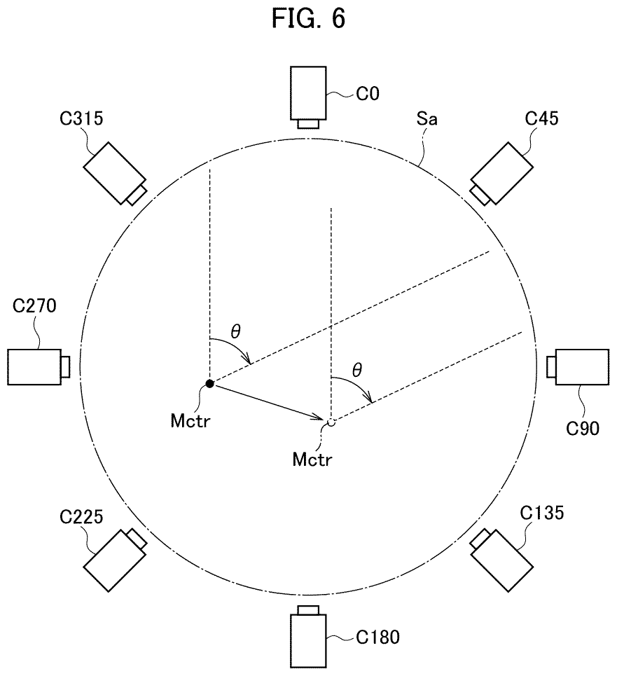

As illustrated in FIG. 6, the center point setting unit 104 sets a movement center point Mctr based on the specific object followed by the specific object following unit 110. The movement center point Mctr may be a center point of a specific object having a predetermined size, for example. As illustrated in FIG. 6, the movement center point Mctr moves from a position indicated by a black circle to a position indicated by a two-dot chain line. As the specific object moves, the movement center point Mctr moves.

When the sales controller 100 receives a purchase request of content at an angle θ, it sells the image data at the angle θ or the composite image data to a purchaser regardless of the position of the movement center point Mctr. In a second embodiment, even if a purchaser purchases content at 0 degrees as the angle θ, for example, it is necessary to sell the composite image data according to the position of the movement center point Mctr. Therefore, in a second embodiment, selling prices of image data and composite image data are not different, and are preferably set to a uniform selling price.

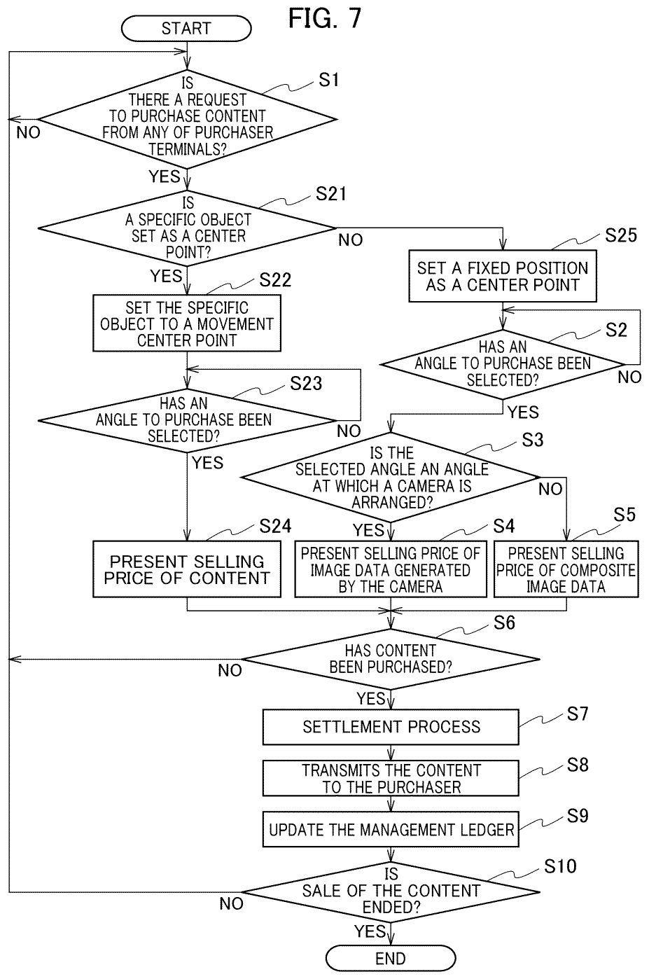

The content sales method executed by the content sales server 10B and processes executed by the content sales program by the sales controller 100 will be described with reference to the flowchart illustrated in FIG. 7. In FIG. 7, the same processes as in FIG. 4 is denoted by the same reference signs, and the description thereof may be omitted.

When the content sales server 10B starts operation, the sales controller 100 determines in step S1 whether there is a request to purchase content from any of the purchaser terminals 40. If there is no request to purchase content (NO), the sales controller 100 repeats a process in step S1. If there is a request to purchase content (YES) in step S1, the sales controller 100 determines in step 21 whether or not a specific object is set as a center point.

If a specific object is set as a center point in step S21 (YES), the sales controller 100 instructs the center point setting unit 104 to set any position of the specific object to the movement center point Mctr in step S22. Subsequently, the sales controller 100 determines in step S23 whether or not an angle to purchase has been selected. If an angle to purchase has not been selected (NO), the sales controller 100 repeats the process in step S23. If an angle to purchase has been selected (YES), the sales controller 100 presents a selling price of content in step S24, and causes the process in step S6 to follow.

If a specific object is not set as a center point in step S21 (NO), the sales controller 100 sets the same fixed position as in FIG. 2 to the center point Ctr in step S25, and causes the process in step S2 to follow. The processes of steps S2 to S10 are the same as those of steps S2 to S10 in FIG. 4.

As described above, the content sales server 10B of the content sales device according to a second embodiment includes the specific object following unit 110 for following a specific object from the subject shot by the plurality of cameras C. The center point setting unit 104 sets any position of a specific object followed by the specific object following unit 110 as the center point Mctr. The composite image generator 103 generates composite image data corresponding to image data obtained by shooting a subject from a position at a predetermined angle in any direction from the center point Mctr, with a predetermined direction from the center point Mctr of the specific object that may move as an angle of 0 degrees.

When a purchaser of content selects an angle in any direction from the center point Mctr to purchase content, the sales controller 100 sells image data stored in the image storage unit 102, or composite image data generated by the composite image generator 103 as the content.

In the content sales method according to a second embodiment, the specific object following unit 110 follows a specific object among subjects shot by the plurality of cameras C, and the center point setting unit 104 sets any position of the specific object followed by the specific object following unit 110 as the center point Mctr. In the content sales method according to a second embodiment, when a purchaser of content selects an angle in any direction from the center point Mctr to purchase content, image data stored in the image storage unit 102 or composite image data generated by the composite image generator 103 is sold as the content.

The content sales program according to a second embodiment causes a computer included in the content sales server 10B to execute a step of following a specific object among subjects and a step of setting any position of the specific object as the center point Mctr. The content sales program according to a second embodiment causes a computer included in the content sales server 10B to execute a step of selling image data or composite image data stored in the image storage unit 102 as content.

According to the content sales server 10B, the content sales method, and the content sales program according to a second embodiment, the content can be sold according to a request of a purchaser of content even when the center point Mctr that may move is set as a center point.

### Third Embodiment

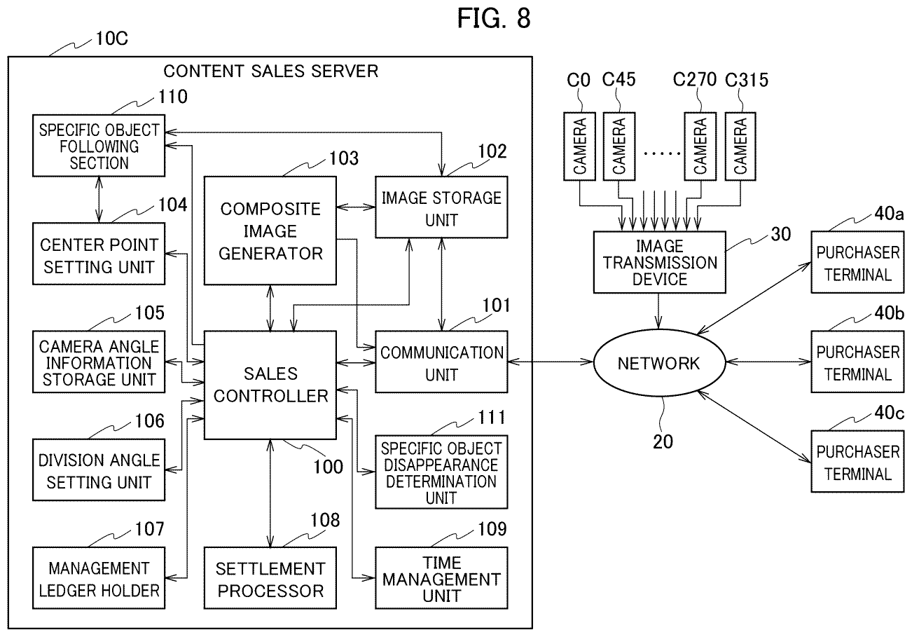

In FIG. 8, a content sales server 10C is connected to the network 20 instead of the content sales server 10B illustrated in FIG. 5. In FIG. 8, the same parts as those in FIG. 5 are denoted by the same reference numerals, and the description thereof may be omitted. The content sales server 10C is a content sales device according to a third embodiment, and executes a content sales method according to a third embodiment. The content sales server 10C executes a content sales program according to a third embodiment.

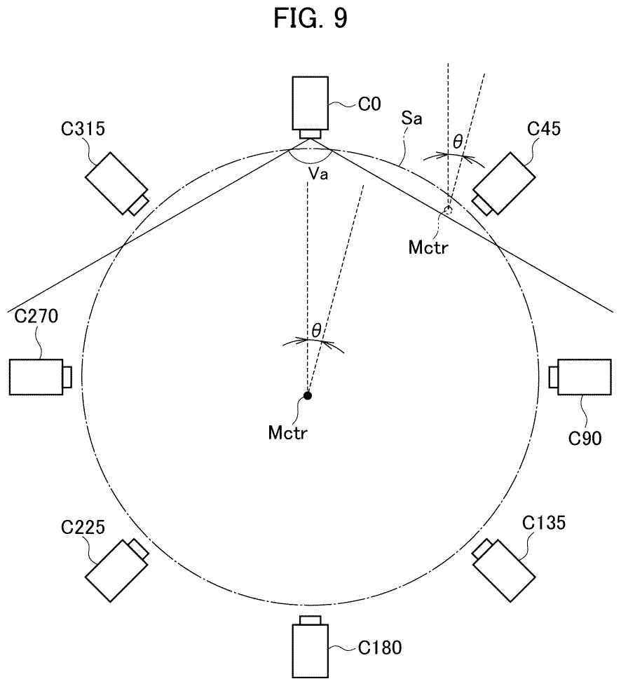

As illustrated in FIG. 8, the content sales server 10C includes a specific object disappearance determination unit 111. As illustrated in FIG. 9, it is assumed that the center point Mctr has moved from a position indicated by a black circle to a position indicated by a two-dot chain line. The center point Mctr indicated by the black circle is located within the viewing angle Va of the camera C0. Although not illustrated, the center point Mctr indicated by the black circle is located within the viewing angle Va of the camera C45. When the center point Mctr is located at the position indicated by the black circle and an angle selected by a purchaser is the angle θ illustrated in FIG. 9, the composite image generator 103 can generate composite image data based on image data generated by the cameras C0 and C45.

However, when the center point Mctr is moved to the position indicated by the two-dot chain line and is located outside the viewing angle Va of the camera C0, the composite image generator 103 cannot generate composite image data based on the image data generated by the cameras C0 and C45. Then, the composite image generator 103 must generate composite image data based only on the image data generated by the camera C45, or generate composite image data based on the image data generated by the camera C45 and the image data generated by another one of the cameras C. For example, the camera C315 among the cameras C includes the center point Mctr located at the position indicated by the two-dot chain line in the viewing angle.

The specific object disappearance determination unit 111 has information on the viewing angle of each camera C, and receives information on the position of the movement center point Mctr set by the center point setting unit 104. The specific object disappearance determination unit 111 determines whether or not a state of image quality deterioration occurs due to a specific object followed by the specific object following unit 110 being out of the viewing angle of one of the two cameras C adjacent in the circumferential direction. The specific object disappearance determination unit 111 may be provided in the sales controller 100.

When the specific object disappearance determination unit 111 determines that the state of image quality deterioration has occurred, the sales controller 100 preferably sells the composite image data at a discounted price lower than the selling price of the composite image data when the specific object disappearance determination unit 111 determined that the state of image quality deterioration has not occurred. The sales controller 100 preferably sells the composite image data at a discounted price with a discount rate set according to the length of time during which the state of image quality deterioration occurs.

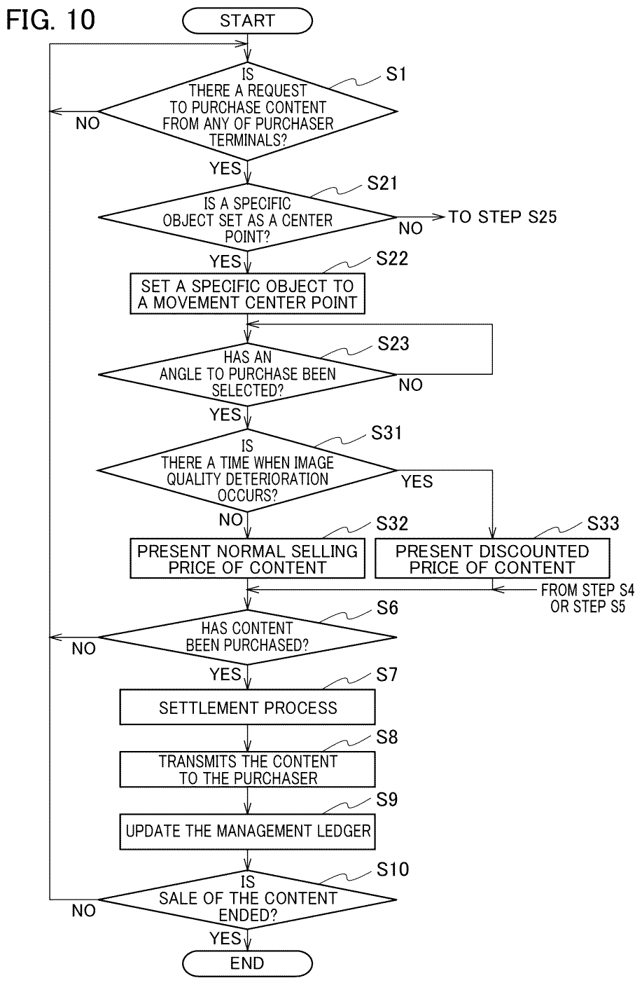

The content sales method executed by the content sales server 10C, and processes that the content sales program causes the sales controller 100 to execute, will be described with reference to the flowchart illustrated in FIG. 10. In FIG. 10, the same processes as those in FIG. 4 or FIG. 7 are denoted by the same reference signs, and the explanation thereof may be omitted.

In step S31 following step S23, the specific object disappearance determination unit 111 determines whether there is a time when image quality deterioration occurs due to the specific object being out of the viewing angle of one of the two cameras C. If there is no time when image quality deterioration occurs (NO), the sales controller 100 presents a normal selling price of the content in step S32, and causes the process in step S6 to follow. If there is time when image quality deterioration occurs (YES), the sales controller 100 presents the discounted price of the content in step S33, and causes the process in step S6 to follow. The processes of steps S6 to S10 are the same as those in steps S6 to S10 in FIG. 7.

In FIG. 10, the illustration of steps S25, and S2 to S5 in FIG. 7 is omitted.

As described above, the content sales server C as the content sales device according to a third embodiment includes the specific object disappearance determination unit 111. The specific object determination disappearance unit 111 determines whether or not a state occurs in which the center point Mctr is out of the viewing angle of a first camera, which is one of two cameras C adjacent in the circumferential direction, based on the position of the center point Mctr in a shooting area. In this state, only composite image data with deteriorated image quality can be generated. Thus, the specific object disappearance determination unit 111 determines whether or not the state of the image quality deterioration has occurred.

When the specific object disappearance determination unit 111 determines that the image quality deterioration state does not occurs, the composite image generator 103 generates composite image data based on image data generated by the two circumferentially adjacent cameras C.

When the specific object disappearance determination unit 111 determines that the image quality deterioration state has occurred, the composite image generator 103 generates composite image data based on the image data generated by a second camera, or the image data generated by the second camera and the image data generated by a third camera. The second camera is the other camera C of the two adjacent cameras in the circumferential direction whose center point Mctr is not outside the viewing angle. The third camera is any camera C other than the first and second cameras whose center point Mctr is within the viewing angle.

In the content sales method according to a third embodiment, the specific object disappearance determination unit 111 included in the content sales server C determines whether or not a state of image quality deterioration occurs due to the specific object being out of the viewing angle of one of the two cameras C. When the specific object disappearance determination unit 111 determines that the state of the image quality deterioration has occurred, the content sales method according to a third embodiment generates composite image data based on only the image data generated by the second camera, or based on the image data generated by the second camera and the image data generated by the third camera.

The content sales program according to a third embodiment causes a computer included in the content sales server 10C to execute a step of determining whether or not a state of image quality deterioration is occurring due to a specific object being out of the viewing angle of one of the two cameras C. The content sales program according to a third embodiment causes a computer to execute a step of generating composite image data when a state of image quality deterioration has occurred, based only on image data generated by the second camera, or image data generated by the second camera and image data generated by the third camera.

According to the content sales server 10C, the content sales method, and the content sales program according to a third embodiment, even if the center point Mctr, which may move, is set as a center point, content according to a request of a purchaser of content can be sold. Furthermore, according to the content sales server 10C, the content sales method, and the content sales program according to a third embodiment, even if the center point Mctr is out of the viewing angle of one of the cameras C, the composite image data can be generated using image data from another one of the cameras C or the like.

### Fourth Embodiment

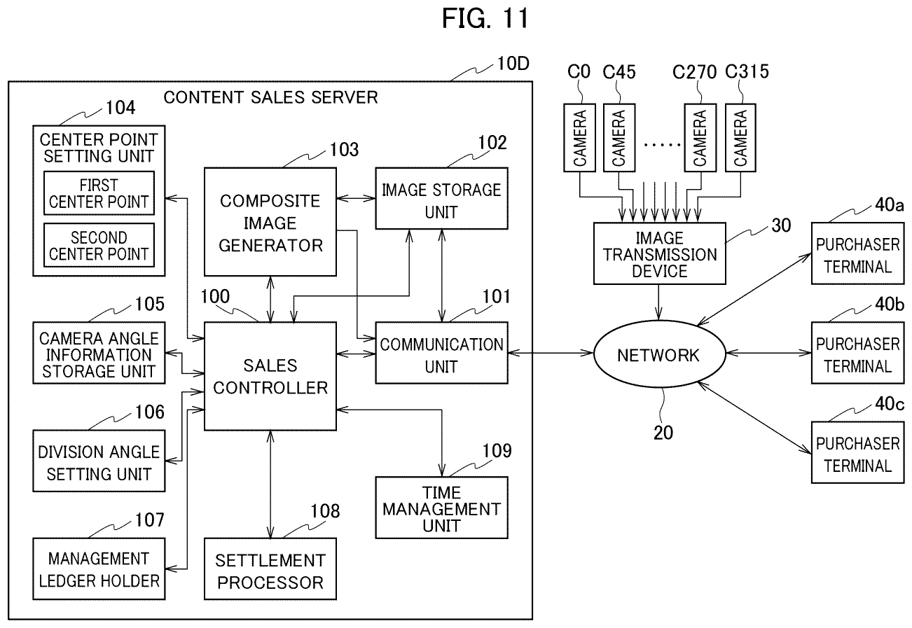

In FIG. 11, a content sales server 10D is connected to the network 20 in place of the content sales server 10A illustrated in FIG. 1. In FIG. 11, the same parts as those in FIG. 1 are denoted by the same reference signs, and the description thereof may be omitted. The content sales server 10D is a content sales device according to a fourth embodiment, and executes a content sales method according to a fourth embodiment. The content sales server 10D executes a content sales program according to a fourth embodiment.

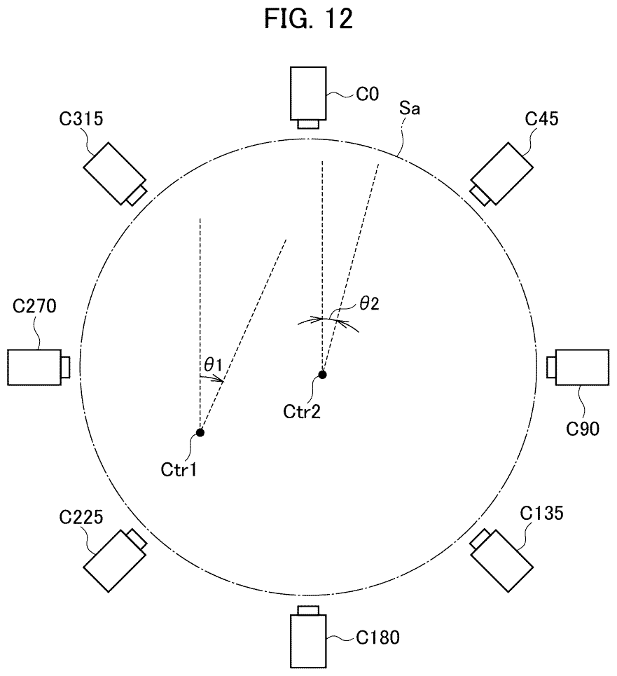

As illustrated in FIG. 11, a first center point and a second center point are set as fixed center points in the center point setting unit 104. Three or more center points may be set in the center point setting unit 104. As illustrated in FIG. 12, fixed center points Ctr1 and Ctr2 are set in the shooting area Sa. A purchaser of content can select one of the center points Ctr1 and Ctr2, and purchase content by selecting an angle in any direction from a selected center point.

In FIG. 12, an angle θ1 is selected for the center point Ctr1, and an angle θ2 is selected for the center point Ctr2. Even if the angle θ1 and the angle θ2 are the same, the center point Ctr1 and the center point Ctr2 are at different positions, so that content provided to purchasers are different from each other. Therefore, according to the content sales server 10D, content can be sold to different purchasers at the center point Ctr1 and the center point Ctr2 apart from exceptions described later.

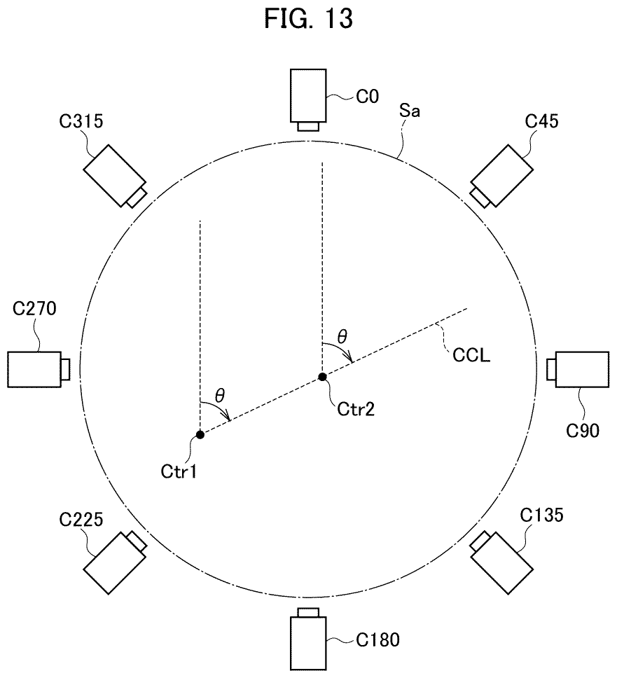

The exceptions will be described with reference to FIG. 13. In FIG. 13, a connecting line connecting the center point Ctr1 and the center point Ctr2 is referred to as a connecting line CCL. It is assumed that a purchaser selects the angle θ at the center point Ctr1. In FIG. 13, a direction of the angle θ selected by the purchaser coincides with a direction of the connecting line CCL. It is assumed that another purchaser selects the angle θ at the center point Ctr2. Then, content purchased by the purchaser who selects the angle θ at the center point Ctr1 and content purchased by the purchaser who selects the angle θ at the center point Ctr2 are substantially the same content.

Therefore, the sales controller 100 sells the content at the angle θ in the selected direction at the center points Ctr1 and Ctr2 to only one purchaser for one time period when the direction selected at the center point selected from the center points Ctr1 and Ctr2 coincides with the direction of the connecting line CCL connecting the center points Ctr1 and Ctr2. The content having the angle θ in the direction coincident with the connecting line CCL is sold to only one purchaser, it is preferable to set a premium price higher than a normal selling price.

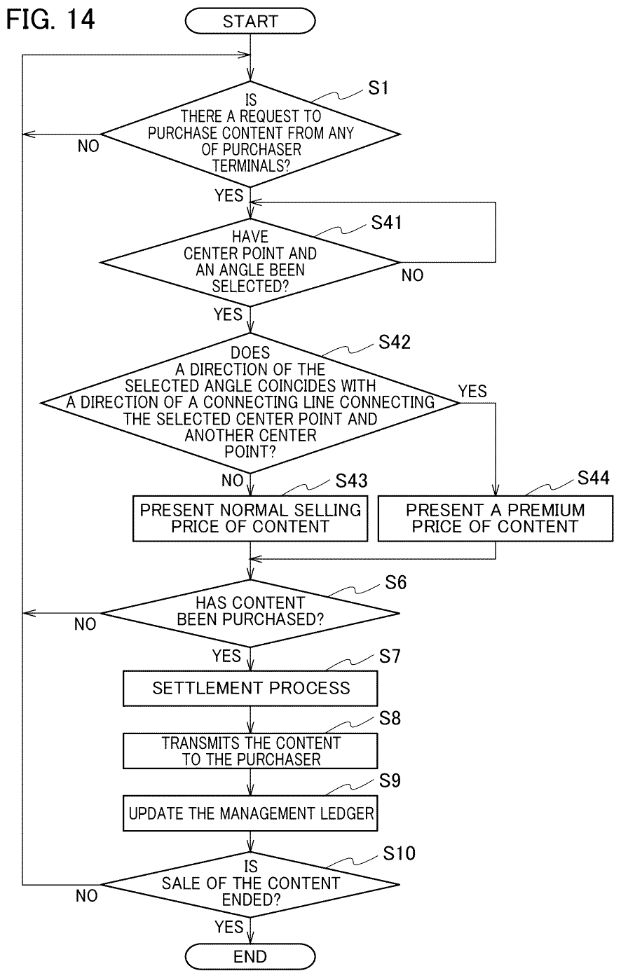

With reference to a flowchart illustrated in FIG. 14, the content sales method executed by the content sales server 10D, and the processes that the content sales program causes the sales controller 100 to execute, will be described. In FIG. 14, the same processes as those in FIG. 4 are denoted by the same reference signs, and the description thereof may be omitted.

The sales controller 100 determines whether or not a center point and an angle have been selected in step S41 following step S1. If a center point and an angle have not been not selected (NO), the sales controller 100 repeats the process in step S41. If a center point and an angle are selected (YES), the sales controller 100 determines in step S42 whether or not the direction of the selected angle coincides with the direction of the connecting line CCL connecting the selected center point and another center point.

If they do not coincide (NO) in step S42, the sales controller 100 presents a normal selling price of content in step S43, and causes the process in step S6 to follow. If they coincide in step S42 (YES), the sales controller 100 presents a premium price of content in step S44, and causes the process in step S6 to follow. The processes in steps S6 to S10 are the same as those in steps S6 to S10 in FIG. 4.

As described above, a plurality of center points are set in the center point setting unit 104 of the content sales server 10D which is the content sales device according to a fourth embodiment. A purchaser of content selects one center point among the plurality of center points, and selects an angle in any direction from the selected center point to purchase the content. The sales controller 100 sells the image data stored in the image storage unit 102 corresponding to the selected angle at the selected center point, or the composite image data generated by the composite image generator 103 as content.

The content sales method according to a fourth embodiment sells image data stored in the image storage unit 102 corresponding to the selected angle at the selected center point, or composite image data generated by the composite image generator 103 as content. The content sales program according to a fourth embodiment causes the computer included in the content sales server 10D to execute a step of selling the image data stored in the image storage unit 102 corresponding to the selected angle at the selected center point or the composite image data as content.

According to the content sales server 10D, the content sales method, and the content sales program according to a fourth embodiment, content according to a request of a purchaser of content can be sold at each of the center points.

### Fifth Embodiment

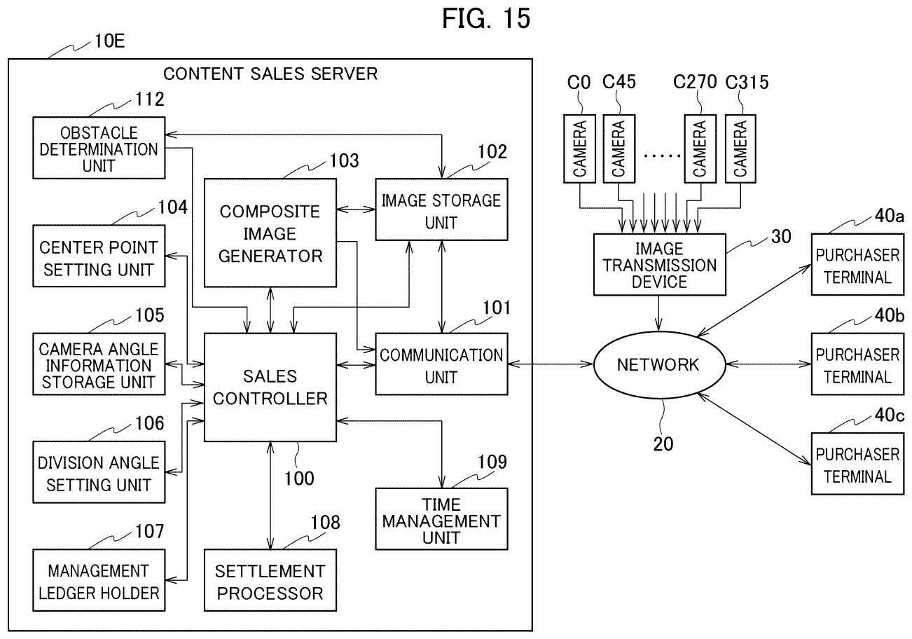

In FIG. 15, a content sales server 10E is connected to the network 20 in place of the content sales server 10A illustrated in FIG. 1. In FIG. 15, the same parts as those in FIG. 1 are denoted by the same reference numerals, and the description thereof may be omitted. The content sales server 10E is a content sales device according to a fifth embodiment, and executes a content sales method according to a fifth embodiment. The content sales server 10E executes a content sales program according to a fifth embodiment.

As illustrated in FIG. 15, the content sales server 10E includes an obstacle determination unit 112. The obstacle determination unit 112 determines presence of an obstacle that hinders shooting of a subject located at the center point Ctr, based on image data generated by each camera C supplied from the image storage unit 102. For example, if a subject shot by the camera C disappears at a certain time and reappears after a predetermined time, it can be determined that shooting of the subject is hindered by an obstacle at that time. By registering features such as color or shape of the subject, it is possible to detect disappearance of the subject.

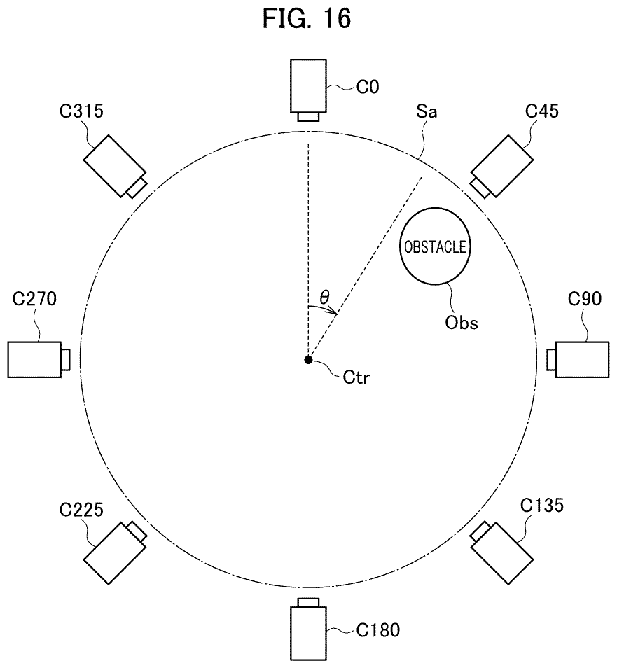

In FIG. 16, it is assumed that an obstacle Obs is present between the center point Ctr and the camera C45 when the purchaser selects the angle θ between the camera C0 and the camera C45. In this case, the composite image generator 103 cannot generate composite image data using the image data generated by the camera C0 and the image data generated by the camera C45. In this case, the composite image generator 103 generates composite image data based only on the image data generated by the camera C0, for example. The composite image generator 103 may generate composite image data based on the image data generated by the camera C0 and the image data generated by the camera C90, for example.

If the obstacle Obs is present in front of the camera C0, the camera C0 cannot generate image data by shooting a subject located at the center point Ctr. In this case, the composite image generator 103 may generate composite image data as a substitute for the image data generated by the camera C0 based on the image data generated by the two cameras C except the camera C0.

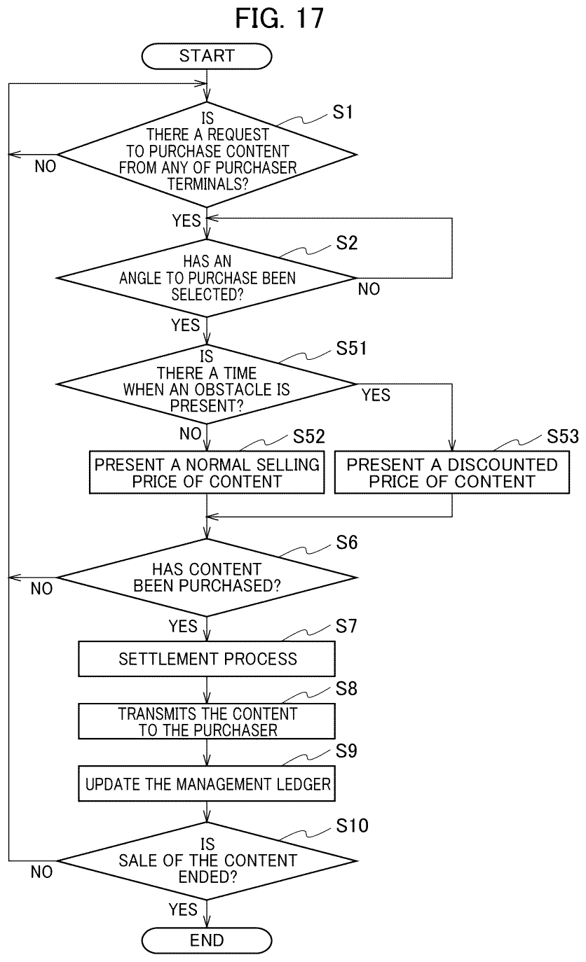

With reference to a flowchart illustrated in FIG. 17, the content sales method executed by the content sales server 10E, and the processes that the content sales program causes the sales controller 100 to execute will be described. In FIG. 17, the same processes as those in FIG. 4 are denoted by the same reference signs, and the description thereof may be omitted. The flowchart in FIG. 17 illustrates processes in the case of on-demand distribution of content.

In step S51 following step S2, the sales controller 100 determines whether or not there is a time when an obstacle is present. If there is no time when an obstacle is present (NO), the sales controller 100 presents a normal selling price of content in step S52, and causes the process in step S6 to follow. If there is a time when an obstacle is present (YES), the sales controller 100 presents a discounted price of content in step S53, and causes the process in step S6 to follow. The processes in steps S6 to 10 are the same as steps S6 to 10 in FIG. 4.

As described above, the content sales server 10E of the content sales device according to a fifth embodiment includes an obstacle determination unit 112 for determining the presence of an obstacle that hinders shooting of a subject when each camera C shoots the subject. The obstacle determination unit 112 determines that there is an obstacle when the camera C selected to generate the composite image data shoots a subject. At this time, the composite image generator 103 generates the composite image data based on image data generated by one or more other cameras C capable of shooting the subject without being affected by the obstacle.

The sales controller 100 preferably sells composite image data when an obstacle is present at a discounted price lower than a selling price of the composite image data generated based on image data generated by selected two cameras C adjacent to each other in the circumferential direction without an obstacle. The sales controller 100 should also sell composite image data at a discounted price when an obstacles is present and the composite image data is sold as a substitute for the image data generated by cameras C0 to C315.

In the content sales method according to a fifth embodiment, the obstacle determination unit 112 included in the content sales server 10E determines the presence of an obstacle that hinders shooting of the subject when each of the cameras C shoots a subject. In the content sales method according to a fourth embodiment, the composite image generator 103 included in the content sales server 10E generates composite image data based on image data generated by one or more other cameras C capable of shooting the subject without being affected by the obstacle.

The content sales program according to a fifth embodiment causes a computer included in the content sales server 10E to execute a step of determining the presence of an obstacle that hinders shooting of a subject when each of the cameras C shoots the subject. The content sales program according to a fifth embodiment causes a computer to execute a step of generating composite image data based on image data generated by one or more other cameras C capable of shooting the subject without being affected by an obstacle.

According to the content sales server 10E, the content sales method, and the content sales program according to a fifth embodiment, content according to a request of a purchaser of content can be sold even if an obstacle that hinders shooting of a subject is present. In a fifth embodiment, the movement center point Mctr may be used instead of the center point Ctr.

### Sixth Embodiment

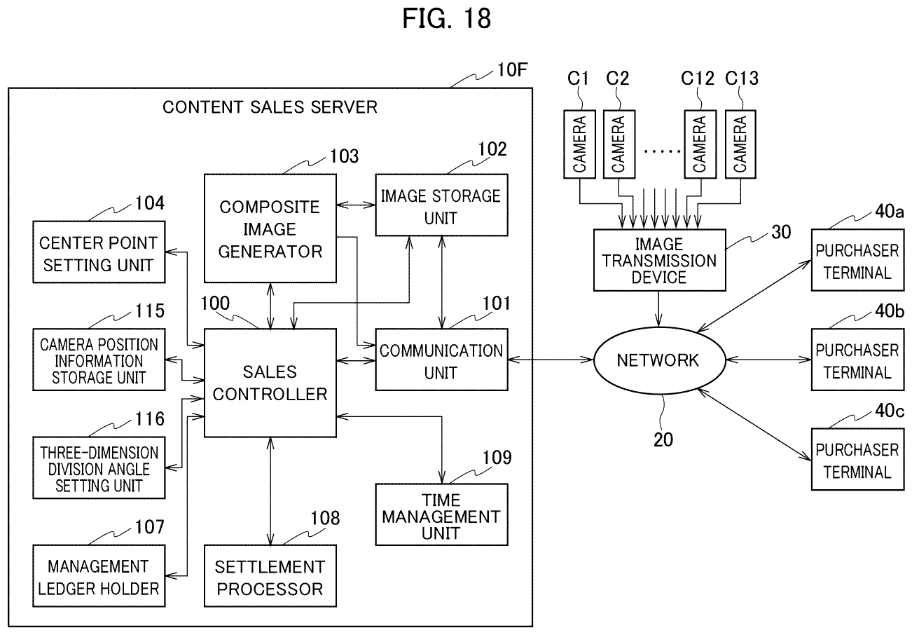

In FIG. 18, a content sales server 10F is connected to the network 20 in place of the content sales server 10A illustrated in FIG. 1. In FIG. 18, the same parts as those in FIG. 1 are denoted by the same reference numerals, and the description thereof may be omitted. The content sales server 10F is a content sales device according to a sixth embodiment, and executes the content sales method according to a sixth embodiment. The content sales server 10E executes a content sales program according to a sixth embodiment.

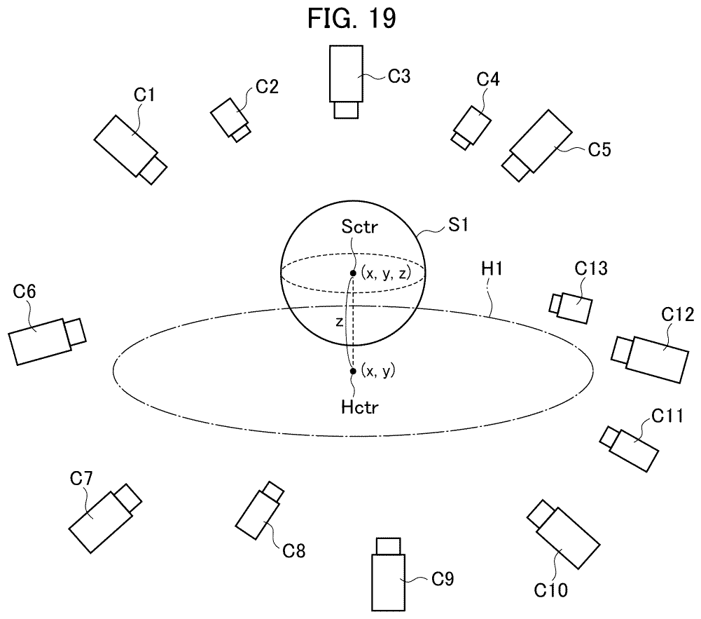

As illustrated in FIG. 19, in a sixth embodiment, the plurality of cameras C are arranged three-dimensionally to surround a center point Sctr set in the shooting area. Here, the plurality of cameras C are thirteen cameras C1 to C13, but the number of cameras C is not limited. The center point Sctr is set at a position away from a center point Hctr of a horizontal plane H1 by a distance of z in a height direction. If the coordinates of the center point Hctr are (x, y), the coordinates of the center point Sctr are (x, y, z).

The cameras C are arranged to face the center point Sctr. When the cameras C are arranged to face the center point Sctr, the lines orthogonal to the angle of view at the horizontal and vertical center of the angle of view of cameras C face the center point Sctr.

As illustrated in FIG. 18, the content sales server 10F includes a camera position information storage unit 115 in place of the camera angle information storage unit 105, and a three-dimension division angle setting unit 116 in place of the division angle setting unit 106. The camera position information storage unit 115 stores the three-dimensional positions of the cameras C1 to C13 illustrated in FIG. 19. The three-dimension division angle setting unit 116 sets a sphere S1 with a predetermined radius around the center point Sctr, and sets an angle in three dimensions as described below. The radius of the sphere S1 is 1 m, for example.

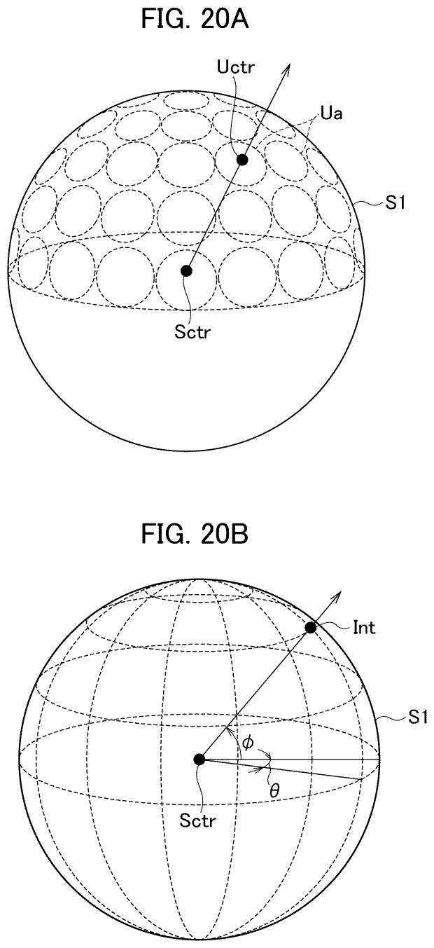

As illustrated in FIG. 20A, the three-dimension division angle setting unit 116 divides the surface of the sphere S1 into unit regions Ua having a predetermined surface area, and sets a plurality of angles in three dimensions to the sphere S1 in a direction connecting the center point Sctr and a center Uctr of each unit region Ua. In the example illustrated in FIG. 20A, the unit region Ua is a circle, but it may be a polygon.

FIG. 20B illustrates another method of setting a plurality of angles. As illustrated in FIG. 20B, an angle in three dimensions is set in a direction connecting the center point Sctr and an intersection point Int between a plurality of parallel lines and a plurality of longitude lines set in the sphere S1. The angle in three dimensions is represented by an angle θ in a longitude direction and an angle φ in a latitude direction. If a plurality of angles in three dimensions are set as illustrated in FIG. 20B, the closer to two poles, the denser the intersection points Int become, so that the angles cannot be set equally. Therefore, it is preferable to set a plurality of angles by the method illustrated in FIG. 20A.

In FIG. 18, the image storage unit 102 stores image data generated by each of the cameras C by shooting a subject located at the center point Sctr. The composite image generator 103 generates composite image data corresponding to image data obtained by shooting a subject from a position between two adjacent cameras C, based on image data generated by at least two adjacent cameras C in the plurality of cameras C.

It is assumed that a purchaser of content selects an angle in a direction in which one of the cameras C is located, and purchases content. At this time, the sales controller 100 sells image data generated by the camera C corresponding to the selected angle stored in the image storage unit 102 as the content. It is assumed that a purchaser of content selects an angle in the direction between two adjacent cameras C among the plurality of cameras C, and purchases content. At this time, the sales controller 100 sells the composite image data generated by the composite image generator 103 as the content.

It is preferable that the sales controller 100 sells the image data stored in the image storage unit 102 at a first selling price, and the composite image data generated by the composite image generator 103 at a second selling price lower than the first selling price.

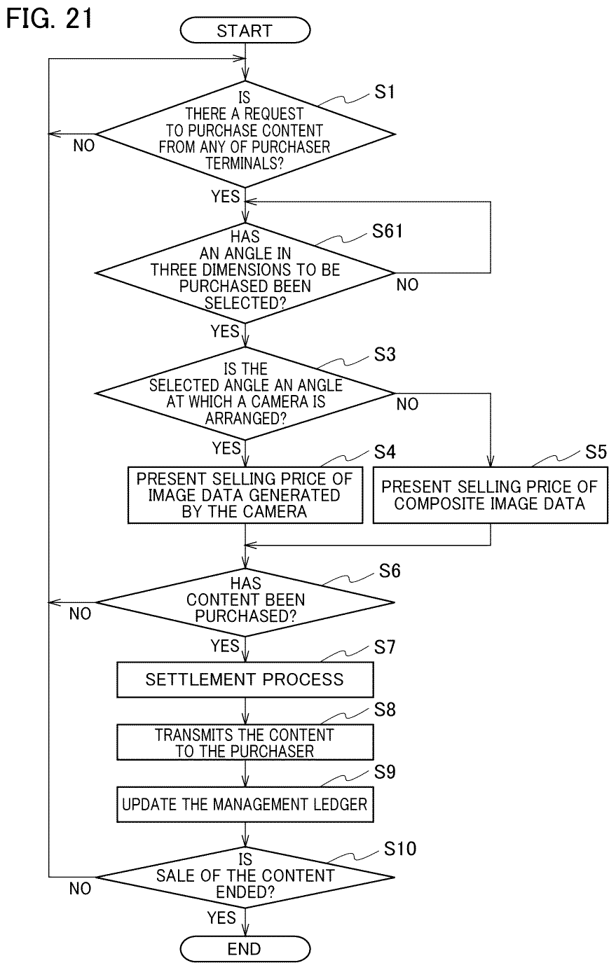

The content sales method executed by the content sales server 10F, and processes that the content sales program causes the sales controller 100 to execute will be described with reference to the flowchart illustrated in FIG. 21. In FIG. 21, the same processes as those in FIG. 4 are denoted by the same reference signs, and the description thereof may be omitted.

In step S61 following step S1, the sales controller 100 determines whether or not an angle in three dimensions to be purchased has been selected. If an angle in three dimensions has not been selected (NO), the sales controller 100 repeats the process in step 61. If an angle in three dimensions has been selected (YES), the sales controller 100 causes the process in step S3 to follow. Steps S3 to S10 are the same as steps S3 to S10 in FIG. 4.

As described above, in a sixth embodiment, the cameras C are arranged three-dimensionally to surround the center point Sctr set in the shooting area, and each camera in the plurality of cameras C is arranged to face the center point Sctr. A purchaser of content selects an angle in three dimensions from the center point Sctr.

The sales controller 100 in the content sales server 10F, which is the content sales device according to a sixth embodiment, sells image data generated by the camera C corresponding to the selected angle in three dimensions, which is stored in the image storage unit 102. Further, the sales controller 100 sells composite image data generated by the composite image generator 103 corresponding to the selected angle in three dimensions.

The content sales server 10F preferably includes the three-dimension division angle setting unit 116, which divides the sphere S1 by a unit region Ua having a predetermined area, and sets a plurality of angles in three dimensions to the sphere S1 in a direction connecting the center point Sctr and the center of each unit region Ua. The sales controller 100 sells content for each angle set in the three-dimension division angle setting unit 116.

In the content sales method according to a sixth embodiment, the sales controller 100 included in the content sales server 10F sells image data generated by the camera C corresponding to the selected angle stored in the image storage unit 102 as content. In a content sales method according to a sixth embodiment, composite image data generated by the composite image generator 103 is sold as content.

The content sales program according to a sixth embodiment causes a computer provided in the content sales server 10F to execute a step of selling image data generated by the camera C corresponding to the selected angle stored in the image storage unit 102 as content. The content sales program according to a sixth embodiment causes a computer included in the content sales server 10F to execute the step of selling composite image data as content.

According to the content sales server 10F, the content sales method, and the content sales program according to a sixth embodiment, content corresponding to an angle in three dimensions according to a request of a purchaser of content can be sold.

The present invention is not limited to first to sixth embodiments described above, and various changes can be made without departing from the scope of the present invention.

What is claimed is:

1. A content sales device comprising:
an image storage unit configured to store image data generated by a plurality of cameras when each of the plurality of cameras is arranged to face an inside of a shooting area, and the plurality of cameras shoot a subject located in the shooting area;
a center point setting unit configured to set a center point in the shooting area;
a composite image generator configured to generate composite image data corresponding to image data obtained by shooting the subject from a position at a predetermined angle in any direction from the center point, based on image data generated by at least two cameras adjacent in a circumferential direction among the plurality of cameras, with a predetermined direction from the center point taken as an angle of 0 degrees; and
a sales controller configured to sell image data stored in the image storage unit or composite image data generated by the composite image generator as content when a purchaser of content selects an angle in any direction from the center point to purchase the content.

2. The content sales device according to claim 1, wherein
each camera in the plurality of cameras is arranged to face the center point set in the shooting area; and
the sales controller sells image data generated by the camera corresponding to a selected angle stored in the image storage unit as content when a purchaser of content purchases content by selecting an angle in a direction in which one of the plurality of cameras is located, and sells composite image data generated by the composite image generator as content when the purchaser purchases content by selecting an angle in a direction between two cameras adjacent in the circumferential direction among the plurality of cameras.

3. The content sales device according to claim 2, wherein the sales controller sells image data stored in the image storage unit at a first selling price, and sells composite image data generated by the composite image generator at a second selling price lower than the first selling price.

4. The content sales device according to claim 1, further comprising a specific object following unit configured to follow a specific object from the subject that has been shot by the plurality of cameras,
wherein the center point setting unit sets any position of the specific object followed by the specific object following unit as the center point.

5. The content sales device according to claim 4, further comprising a specific object disappearance determination unit configured to determine whether or not a state of image quality deterioration occurs, in which the center point is out of the viewing angle of a first camera that is one of two cameras adjacent in the circumferential direction of the plurality of cameras, and composite image data with deteriorated image quality is forced to be generated, due to a position of the center point in the shooting area,
wherein:
the composite image generator generates the composite image data based on image data generated by two cameras adjacent in the circumferential direction among the plurality of cameras when the specific object disappearance determination unit determines that the state of image quality deterioration does not occur; and
the composite image generator generates the composite image data, based on image data generated only by a second camera, which is the other camera of the two cameras adjacent in the circumferential direction and whose center point is not out of the viewing angle, or based on image data generated by the second camera and image data generated by a third camera other than the first and second cameras, whose center point is within the viewing angle, when the specific object disappearance determination unit determines that the state of image quality deterioration occurs.

6. The content sales device according to claim 5, wherein the sales controller sells the composite image data generated by the composite image generator when the specific object disappearance determination unit determines that the state of image quality deterioration has occurred, at a selling price discounted compared to the selling price of the composite image data generated by the composite image generator when the specific object disappearance determination unit determines that the state of image quality deterioration does not occur.

7. The content sales device according to claim 1, wherein
the center point setting unit sets a plurality of center points in the shooting area;
the composite image generator generates composite image data corresponding to image data obtained by shooting a subject located at each center point from a position at a predetermined angle in any direction from each center point, based on image data generated by at least two cameras adjacent in the circumferential direction among the plurality of cameras, with a predetermined direction from each center point of the plurality of center points set in the shooting area as an angle of 0 degrees; and
the sales controller sells, as content, image data stored in the image storage unit or composite image data generated by the composite image generator corresponding to the selected angle at the selected center point when the purchaser of content selects one of the center points and selects an angle in any direction from the selected center point to purchase the content.

8. The content sales device according to claim 7, wherein the sales controller sells the content at the angle in the selected direction at two center points to only one purchaser for one time period when the direction selected from the selected center points coincides with the direction of a connecting line connecting the two center points including the selected center points in the plurality of center points.

9. The content sales device according to claim 1, further comprising an obstacle determination unit configured to determine whether an obstacle is present that hinders shooting of the subject when each camera shoots the subject;
wherein the composite image generator generates the composite image data based on image data generated by one or more other cameras capable of shooting the subject without being affected by the obstacle when the obstacle determination unit determines that an obstacle is present when the camera selected for generating the composite image data shoots the subject.

10. The content sales device according to claim 9, wherein, when the obstacle determination unit determines that an obstacle is present during shooting of the subject by the camera selected for generating the composite image data, and when the composite image generator generates the composite image data based on image data generated by the one or more other cameras, the sales controller sells the composite image data at a selling price discounted compared to a selling price of the composite image data when the obstacle determination unit determines that no obstacle is present during shooting of the subject by the camera selected for generating the composite image data, and the composite image generator generates the composite image data based on image data generated by the selected camera.

11. The content sales device according to claim 1, wherein the plurality of cameras are arranged three-dimensionally to surround the center point set in the shooting area.

12. The content sales device according to claim 11, further comprising a three-dimension division angle setting unit configured to divide a sphere surrounding the center point into unit regions having a predetermined surface area, and to set a plurality of angles in three dimensions to the sphere in directions connecting the center point and centers of the unit regions,
wherein the sales controller sells the content for each angle set in the three-dimension division angle setting unit.

13. The content sales device according to claim 1, wherein the sales controller sells the content at each angle to only one purchaser for one time period.

14. A content sales method comprising:
storing image data generated by a plurality of cameras using an image storage unit included in a content sales server, when each of the plurality of cameras is arranged to face the inside of a shooting area, and the plurality of cameras shoot a subject located in the shooting area;
setting a center point in the shooting area by a center point setting unit included in the content sales server;
generating composite image data corresponding to image data obtained by shooting the subject from a position at a predetermined angle in any direction from the center point, with a composite image generator included in the content sales server, based on image data generated by at least two cameras adjacent in a circumferential direction among the plurality of cameras, with a predetermined direction from the center point taken as an angle of 0 degrees; and
selling image data stored in the image storage unit or composite image data generated by the composite image generator as content with a sales controller, when a purchaser of content selects an angle in any direction from the center point to purchase the content.

15. A content sales program stored in a non-transitory storage medium causing a computer to execute the steps of:
storing image data generated by a plurality of cameras when each camera in the plurality of cameras is arranged to face the inside of a shooting area, and the plurality of cameras shoot a subject located in the shooting area;
setting a center point in the shooting area by a center point setting unit included in a content sales server;
generating composite image data corresponding to image data obtained by shooting the subject from a position at a predetermined angle in any direction from the center point, based on image data generated by at least two cameras adjacent in a circumferential direction among the plurality of cameras, with a predetermined direction from the center point taken as an angle of 0 degrees; and
selling image data stored in the image storage unit or composite image data as content when a purchaser of content selects an angle in any direction from the center point to purchase the content.
